(19) United States
(12) Patent Application Publication
(10) Pub. No.: US 2011/0247608 A1
(43) Pub. Date: Oct. 13, 2011

(54) METHOD AND DEVICE FOR TREATING BIOGENIC MATERIAL

(75) Inventors: Thomas Huegle, Worms (DE); Ralf Weigel, Bobenheim (DE)

(73) Assignee: DEMETRION DEUTSCHLAND AG, KAISERSLAUTERN (DE)

(21) Appl. No.: 13/081,511

(22) Filed: Apr. 7, 2011

Related U.S. Application Data
(60) Provisional application No. 61/322,561, filed on Apr. 9, 2010.

(51) Int. Cl. C08B 37/00; B01J 19/00

(52) U.S. Cl. 127/1; 127/36

(57) ABSTRACT

A method of subjecting a flowable suspension comprising a biogenic material to a temperature hydrolysis includes passing the flowable suspension through a first downward conduit section. The flowable suspension is passed through a first connecting conduit section and a first upward part. The first connecting conduit section is configured to connect an outlet of the first downward conduit section with an inlet of a second downward conduit section. The flowable suspension is passed through the second downward conduit section. A first flow velocity in the first upward part exceeds a second flow velocity in each of the first downward conduit section and the second downward conduit section.

### CROSS REFERENCE TO PRIOR APPLICATIONS

Priority is claimed to U.S. Patent Application No. 61/322,561, filed Apr. 9, 2010. The entire disclosure of said application is incorporated by reference herein.

### FIELD

The invention relates to a method and a device for subjecting a flowable suspension comprising biogenic material to a temperature hydrolysis.

### BACKGROUND

Biogenic material, including waste, can be converted in a wealth of useful products by fermentation which involves the use of living organisms such as bacteria or other microorganisms. For example, methane containing biogas can be generated by anaerobic microbial digestion in a fermentation vessel. In multiple steps, the microorganisms break down the complex macromolecules of the biogenic material, thereby generating biogas comprising methane, carbon dioxide, water and other gaseous molecules. Subsequently, the biogas is cleaned and then converted into electrical and thermal energy in a combustion engine.

In general, of the many steps performed by the microorganisms in the fermentation vessel, the hydrolysis step is the slowest and therefore determines the overall speed of anaerobic microbial degradation. In order to provide for faster hydrolysis, it has been suggested to subject the biogenic material to a temperature hydrolysis step before introducing it into the fermentation vessel. Temperature hydrolysis involves exposing the biogenic material to elevated temperatures in order to induce hydrolysis of complex macromolecules. It has been found that the hydrolysis of cellulose and hemicellulose can be expedited by the application of high temperatures.

Experimental temperature hydrolysis installations have been built in which a suspension of biogenic material is passed through a series of horizontally extending shell and tube heat exchanger for heating up the suspension, a horizontally extending tube-type hydrolysis reactor, and another series of horizontally extending shell and tube heat exchanger for cooling town the suspension again, before it is passed into the fermentation vessel.

DE 197 23 510 C1 describes a device where, downstream of a mashing vessel, a suspension of biogenic residues under high pressure circles in a loop-type hydrolysis reactor. The reactor has a double wall through which thermal oil is circulated to heat up the suspension in the reactor to maximum temperature of 250° C. The pressure in the reactor is chosen high enough to maintain the suspension in the liquid phase while hydrolysis takes place in the reactor.

DE 43 08 920 A1 describes a device for subjecting biogenic residue to a chemo-physical hydrolysis in a reactor provided downstream of an enzymatic hydrolysis reactor. The material is pressed out producing an eluate and a remainder, the latter being fed into the chemo-physical hydrolysis reactor through an inlet at the bottom of the reactor. A jet of hot steam is introduced into the material to heat it up and an acid is added to aid hydrolysis. When the material reaches the top of the reactor, a leach is added to neutralize the acid. The material is then fed back into the enzymatic hydrolysis reactor.

DE 77 33 614 U describes a heat exchanger of the 2-pass countercurrent type, which comprises two parallel bundles of double-walled tubes. A first medium flows through the inner tubes while a second medium flows in the spaces between the two walls. More particularly, the first medium flows downward through the inner tubes of the first bundle and then arrives in a chamber at the bottom of the heat exchanger from where it is led in the opposite direction through the inner tubes of the second bundle. The second medium flows downwards between the walls of the tubes of the second bundle and is then redirected at the bottom to flow back upwards between the walls of the tubes of the first bundle.

The effectiveness of the hydrolysis device can be affected by sedimentation of the biogenic material when a suspension of biogenic material is led through a series of heat exchangers and hydrolysis reactors. Sedimentation can, for example, entail incrustations at hot parts of heat exchangers, impairing the heat transfer. In the worst case, the sedimentation can lead to an outright blockage of the device. Regular cleaning of the device may become necessary which increases maintenance costs, which include the costs incurred by down times of the device.

### SUMMARY

An aspect of the present invention is to reduce costs and improve the effectiveness of a temperature hydrolysis.

In an embodiment, the present invention provides a method of subjecting a flowable suspension comprising a biogenic material to a temperature hydrolysis which includes passing the flowable suspension through a first downward conduit section. The flowable suspension is passed through a first connecting conduit section and a first upward part. The first connecting conduit section is configured to connect an outlet of the first downward conduit section with an inlet of a second downward conduit section. The flowable suspension is passed through the second downward conduit section. A first flow velocity in the first upward part exceeds a second flow velocity in each of the first downward conduit section and the second downward conduit section.

### BRIEF DESCRIPTION OF THE DRAWINGS

The present invention is described in greater detail below on the basis of embodiments and of the drawings in which:

FIG. 1 shows a simplified process flow diagram of a method and device according to the present invention;

FIG. 2 shows a simplified representation of an exemplary embodiment of the present invention, in which the downward conduit sections form parts of two heat exchangers; and

FIG. 3 shows a cross-section through the heat exchangers along the plane A-A in FIG. 2.

### DETAILED DESCRIPTION

In an embodiment, the present invention provides a method of subjecting a flowable suspension comprising biogenic material to a temperature hydrolysis by passing it successively through a first downward conduit section, a first connecting conduit section which connects the outlet of the first downward conduit section with the inlet of a second downward conduit section, and the second downward conduit section, wherein part of the first connecting conduit section is formed by a first upward part through which the suspension is passed, and the flow velocity in the upward part is higher than the flow velocity in each of the downward conduit sections.

In an embodiment, the present invention also provides a device for subjecting a flowable suspension comprising biogenic material to a temperature hydrolysis, the device having first and second downward conduit sections for the suspension to pass through sequentially, and a first connecting conduit section that connects the outlet of the first downward conduit section with the inlet of the second downward conduit section, wherein part of the first connecting conduit section is formed by a first upward part so that the suspension flowing from the first to the second downward conduit section passes through the first upward part, and the cross-sectional areas of flow of the first upward part is smaller than the cross-sectional area of flow of each of the downward conduit sections.

The inventors have found that at low flow velocities, sediment formation is more likely to occur. They have also found that sediment formation is more likely to occur if the suspension flows in a horizontal direction. Thus, by letting the suspension flow downwards at slow velocity and then letting it flow back upwards at higher velocity, sediment formation can be prevented.

In the context of the present disclosure, “temperature hydrolysis” means that the suspension is subjected to an elevated temperature to induce or facilitate hydrolysis. In the context of the present disclosure, the flow velocity in a given part of the conduit section is defined as the average flow velocity across the cross-sectional area of flow. In the context of the present disclosure, “downward” means that in operation, the intended direction of flow of the suspension and the direction of gravity draw an angle of less than 90° (based on a 360° full circle), and “horizontal” means perpendicular to the direction of gravity.

The flowable suspension can, for example, be an aqueous suspension of biogenic material. The biogenic material can, for example, be reduced to small pieces, such as in a mill or a macerator and mixed with water or, for example, with recyclate coming from a fermenter, or with a liquid component of the recylcyte obtained by means of a separation device. The biogenic material may be renewable raw material, for example, renewable vegetable raw material such as corn, sugar-beet, sugar-cane, straw or wood. It may also be a biogenic residue such as organic industrial or agricultural waste, sewage sludge, slaughter waste, kitchen slops, food leftovers and adulterated food stuff. The invention can, for example, be used with biogenic material comprising cellulose and/or hemi-cellulose and/or lignin. A fraction of biogenic material in the suspension can, for example, be between 2 and 30%, for example, between 4 and 20%, for example, between 8 and 15%, or between 10 and 13% in terms of dry mass of biogenic material.

In an embodiment of the method of the present invention, subsequent to the second downward section, the suspension can be passed through one or more further connecting conduit sections and downward conduit sections, each of the further connecting conduit sections connecting the outlet of a downward conduit section being previous in sequence with the inlet of a downward conduit section being next in sequence. Part of each of the further connecting conduit sections can, for example, be formed by an upward part which the suspension is passed through, the flow velocities in each of the further upward parts being higher than flow velocities in each of the downward conduit sections.

One or more or the connecting conduit sections may comprise several parts. These may include upward parts as well as horizontal or even downward parts. The flow velocities in each upward part of the connecting conduit section(s) can, for example, be higher than the flow velocities in each of the downward conduit sections. The flow velocities in each horizontal part of the connecting conduit section(s) can, for example, be higher than the flow velocities in each of the downward conduit sections. The flow velocities in each part of the connecting conduit section(s) can, for example, be higher than the flow velocities in each of the downward conduit sections.

The flow velocity in each of the upward parts, for example, in every horizontal or upward part, or every part of the connecting conduit section(s), can, for example, be at least twice as high as the flow velocity in each of the downward conduit sections, for example, at least four times, at least eight times, at least twelve times, at least sixteen times, or at least nineteen times as high.

In an embodiment of the present invention, the flow velocity in each of the upward parts, for example, in every horizontal or upward part, or in every part of the connecting conduit sections, can, for example, be higher than 0.5 meters per second (m/s), higher than 1 m/s, or equal to or higher than 1.5 m/s. In an embodiment of the present invention, the flow velocity in each of the downward conduit sections can, for example, be lower than ¼ meters per second (m/s), lower than ⅛ m/s, lower than 1/16 m/s, or equal to or lower than 1/19 m/s.

In an embodiment, the present invention provides a device with one or more further downward conduit sections for the suspension to pass through after the second downward conduit section, and one or more further connecting conduit sections that connect the outlet of a downward conduit section being previous in sequence with the inlet of a downward conduit section being next in sequence. Part of each of the further connecting conduit sections can, for example, be formed by an upward part so that the suspension flowing from the previous to the next downward conduit section passes through the respective upward part, the cross-sectional areas of flow of each of the further upward parts being smaller than the cross-sectional areas of flow of each of the downward conduit sections.

The downward conduit sections may comprise a single or several parallel tubes. Likewise, the connecting conduit sections or parts of them may comprise single or several parallel conduits. In the case of several parallel tubes, the cross-section area of flow is the sum of the cross-sectional areas of flow of the individual parallel tubes.

The cross-sectional areas of flow in every horizontal or upward part of the connecting conduit sections can, for example, be higher than the cross-sectional area of flow in each of the downward conduit sections.

In an embodiment of the present invention, at least one of the downward conduit sections forms the part of a heat exchanger in which heat is transferred from or to the suspension while it passes through the conduit section. The heat exchanger can, for example, be a shell and tube-type heat exchanger, comprising one or more tubes extending lengthwise inside a tube-like shell. Several tubes can, for example, extend lengthwise, forming a bundle. The suspension can, for example, flow through the tube or tubes, the latter thus forming the downward conduit sections. A flowable heat transfer medium runs through the shell, for example, over the tubes. However, embodiments of the present invention are also possible in which the suspension flows through the shell and the heat transfer medium flows through the tube or tubes. The heat exchanger can, for example, be of the counter current-type, i.e., the suspension can flow in a direction opposite to the direction of the heat transfer medium. Thus, in the shell and tube-heat exchanger, the heat transfer medium runs upwards, in opposite direction to the downwards flowing suspension. The heat transfer medium can, for example, be water or thermal oil.

In an embodiment of the present, invention, heat may be transferred in a heat exchanger directly from the suspension in one part of the device to the suspension in another part of the device. In this case, the suspension would take the role of the heat transfer medium in the heat exchanger. For example, the suspension downstream of the hydrolysis reactor or reactors may transfer heat in one or more heat exchangers directly to the suspension upstream of the hydrolysis reactor or reactors.

In an embodiment of the present invention, in a series of two or more consecutive downward conduit sections, each section forms the part of a heat exchanger in which heat is transferred from or to the suspension while it passes through the conduit section. Each of the two or more consecutive downward conduit sections can, for example, form part of a different heat exchanger.

The heat transfer medium can, for example, flow through the series of heat exchangers in an opposite direction. The order is thus such that it first runs through the heat exchanger which the suspension runs through last and last runs through the heat exchanger through which the suspension runs first. The series of heat exchangers may serve to cool the suspension or to heat the suspension. At least one, for example, at least two or three, series of heat exchangers for heating, and at least one, for example two or three, series of heat exchangers for cooling the suspension, can be provided.

The heat transfer medium may run through a heat exchanger or a series of heat exchangers for cooling and a heat exchanger or series of heat exchangers for heating successively, for example, thereby forming an at least partly closed circuit.

The suspension can, for example, be heated to a temperature of above 100° C., for example above 140° C., above 180° C., above 220° C., or above 240° C.

At least one of the downward conduit sections can, for example, form part of a hydrolysis reactor, for example, a tube reactor, for maintaining the suspension within a certain temperature and pressure range as it passes through the reactor. The reactor(s) for this purpose can, for example, be provided with an appropriate insulation. Two or more consecutive downward conduit sections can, for example, each form part of a hydrolysis reactor. Each of the downward conduit sections can, for example, form part of another hydrolysis reactor.

In an embodiment of the present invention, the device can comprise a sequence of at least one heat exchanger or at least one series of heat exchangers for heating up the suspension, followed downstream by a hydrolysis reactor or a series of hydrolysis reactors, followed further downstream by at least one heat exchanger or at least one series of heat exchangers for cooling down the suspension again. With this embodiment of the present invention, by passing through the sequence, the suspension can be heated to within a certain temperature range for hydrolysis, maintained at this temperature for a certain period of time, and then cooled down again for further processing. The suspension leaving the device may, for example, be subjected to anaerobic fermentation, such as for the production of biogas. Alternatively or additionally, the suspension leaving the device may be used for the production of other organic substances such as alcohols, organic acids or ketones.

One type of temperature hydrolysis is temperature-pressure hydrolysis which involves pressuring the suspension in addition to heating it in order to prevent the liquid fraction of the suspension from vaporizing. The pressure can, for example, be above 5 bar, above 10 bar, above 20 bar or above 30 bar. Pressure means can, for example, be provided to pressurize the suspension, such as a pressure pump. The pressure pump can, for example, be provided upstream of the first or upstream of the second downward conduit section or series of conduit sections. Expansion means can, for example, be provided downstream of the pressure means, for example, downstream of the last or downstream of the second to last downward conduit section or series of conduit sections. An example of an expansion means is an expansion valve.

In an embodiment of the present invention, the downward conduit sections can be inclined relatively to the horizontal by at least 40°, for example by at least 50°, by at least 60°, or by at least 80°. In an embodiment of the present invention, the downward conduit sections can, for example, be essentially vertical.

In an embodiment of the present invention, the upward parts of the connecting conduit sections can be inclined relatively to the horizontal by at least 40°, for example, by at least 50°, by at least 60°, or by at least 80°. In an embodiment of the present invention, the upward parts of the connecting conduit sections can be, for example, essentially vertical.

In an embodiment of the present invention, the cross-sectional area of flow of the upward parts, for example, every horizontal or upward part, or for example, every part of the connecting conduit section(s) of the connecting conduit sections, can be equal or less than half the cross-sectional area of flow of the downward conduit sections, for example, equal or less than 1/4, equal or less than 1/8, equal or less than 1/16, or less than 1/19 of the cross-sectional area of flow of the downward conduit sections.

In an embodiment of the present invention, the cross-sectional area of flow in each of the upward parts, for example, in every horizontal or upward part, or for example, in every part of the connecting conduit sections, can be equal or lower than 8,000 square millimetres (mm²), equal or lower than 4,000 mm², or equal or lower than 2,000 mm². In an embodiment of the present invention, the cross-sectional area of flow in each of the downward conduit sections can be equal or higher than 10,000 mm², equal or higher than 20,000 mm², or equal or higher than 40,000 mm².

The length of each of the downward conduit sections can, for example, be at least 2 m, at least 3 m, at least 4 m, or at least 5 m.

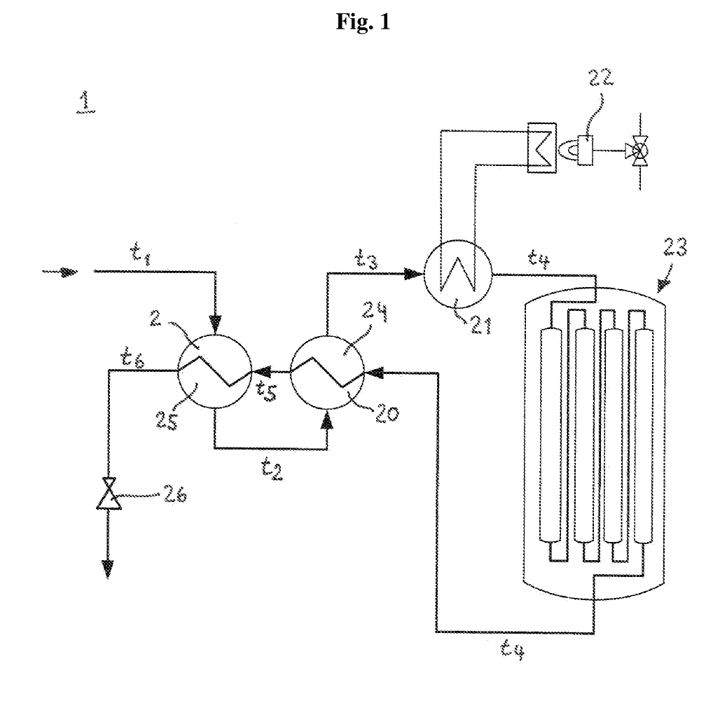

An embodiment of the device 1 according to the present invention is illustrated in FIG. 1 by means of a simplified process flow diagram. Biogenic material has been reduced to small pieces in a mill or a macerator (not shown) and has then been suspended in the liquid component of an aqueous recirculate coming from a fermenter (not shown) to form a suspension comprising about 10 to 15% biogenic material (with respect to the dry mass of the biogenic material). The liquid component has been separated from the remainder by means of a separation device (not shown). The suspension is pressured by a pressure pump (not shown) to approximately 25 bar and then introduced at a temperature t1 of approximately 20° C. into a series 2 comprising four consecutive identical downward conduit sections, and three connecting conduit sections which connect adjacent downward conduit sections. Each downward conduit section forms the tube bundle of a shell and tube-heat exchanger.

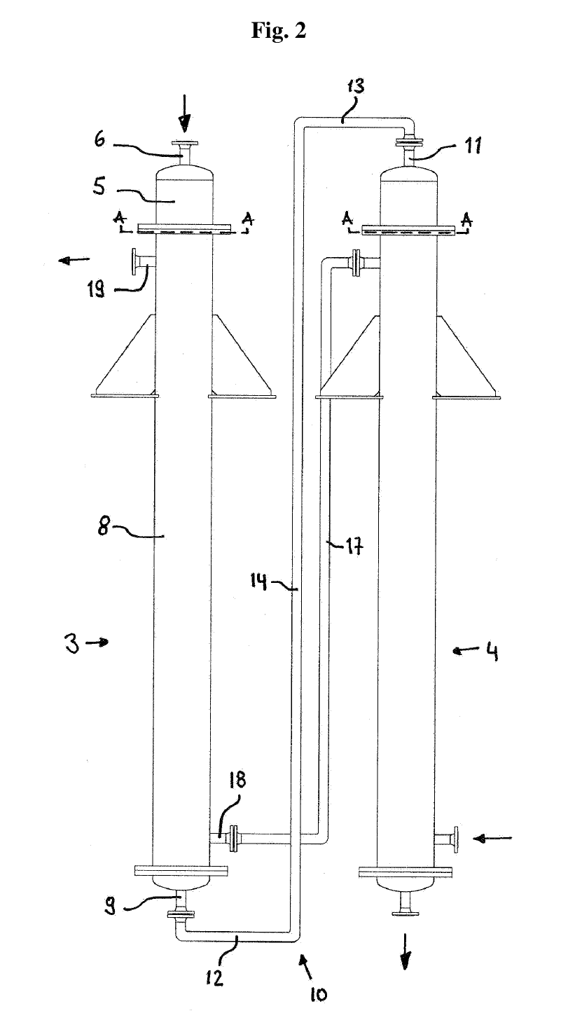

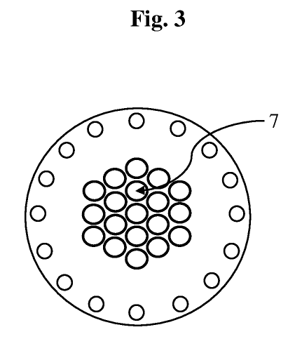

For exemplary illustration, in FIG. 2, two adjacent heat exchangers 3 and 4 of a series of heat exchangers are shown. The suspension enters a discharge chamber 5 at the top of the first heat exchanger 3 through an inlet 6. From there, it is led into nineteen parallel tubes 7 with an inner diameter of approximately 50 mm that run down the remaining part 8 of the heat exchanger to leave the heat exchanger 3 at the outlet 9. In FIG. 3, which shows a cross-section through the plane A-A in FIG. 2, the onsets of nineteen tubes 7 can be seen. The connecting conduit section 10 that connects the outlet 9 with the inlet 11 of the next heat exchanger 4 comprises of two short horizontal parts 12, 13 and a vertical part 14. The cross-section of the connecting conduit section 10 is the same as that of the tubes 7, approximately 50 mm. Water as a heat transfer medium enters the shell of the second heat exchanger 4 through the inlet 15, flows upward past the tubes to leave the heat exchanger as outlet 16. The shell has an inner diameter of approximately 350 mm. From outlet 16, the water is led by means of pipe 17 to the inlet 18 of the first heat exchanger 3, which it leaves through the outlet 19.

In order to enable servicing of individual heat exchangers 3, 4 without having to interrupt operation of the device, bypass pipes (not shown) are provided as well as valves (not shown) in the bypass and at the inlet and the outlet of the heat exchangers 3, 4. With the valve in the bypass, the bypass can be opened for the suspension to bypass the heat exchanger 3, 4 and with the valves at the inlet and the outlet of the heat exchanger 3, 4, the heat exchanger 3, 4 can be cut off from the system in which the suspension flows. The heat exchanger 3, 4 can then be opened or even removed, if necessary.

The suspension leaves the series 2 of heat exchangers at a temperature t2 of about 100° C. From there, it is passed into another series 20 of four heat exchangers, which are essentially identical to the previous series of heat exchangers but use thermal oil rather than water as a heat transfer medium. The suspension leaves this second series of heat exchangers at a temperature t3 of approximately 140° C. to enter a third series 21 of two heat exchangers which again are essentially of the type shown in FIG. 2 and use thermal oil heated by a heat source 22 or the waste heat of a combustion engine (not shown) run by the biogas coming from the fermenter. The suspension leaves the series of heat exchangers 21 at a temperature t4 of about 190° C. to enter a series of 23 of at least two, in the present embodiment four, tube-type hydrolysis reactors. These reactors comprise of at least two, in the present embodiment four, downward conduit sections with a volume that provides a statutory hydraulic retention time of at least 20 minutes even in the event that one of the tube-type hydrolysis reactors is excluded of the hydrolysis process, for example, for maintenance, connected by a connecting conduit section essentially identical to the connecting conduit section 10 used to connect the heat exchangers. The tube-type hydrolysis reactors are also connected in such a way that the hydrolysis process must not be interrupted for maintenance. The reactors are insulated by an appropriate insulating material to ensure that the suspension is maintained at an essentially constant temperature.

The suspension is then led to another series 24 of four heat exchangers essentially identical to the series of heat exchangers 20. Thermal oil as a heat transfer medium circulates between the series of heat exchangers 20 and 24 in order to use the heat discharged from the suspension to the thermal oil in the series 24 of heat exchangers to heat the suspension in the series 20 of heat exchangers. The suspension leaves the series 24 of heat exchangers at a temperature t5 of approximately 125° C. to enter a final series 25 of heat exchangers. Here, the suspension is cooled down using water that circulates between the series 25 of heat exchangers and the series 2 of heat exchangers. The suspension leaves the series 25 of heat exchangers at a temperature t6 of approximately 70° C. From there, it is led to an expansion valve 26 to reduce the pressure of the suspension again to atmospheric pressure and then into the fermenter to generate biogas by means of anaerobic fermentation.

The present invention is not limited to embodiments described herein; reference should be had to the appended claims.

What is claimed is:

1. A method of subjecting a flowable suspension comprising a biogenic material to a temperature hydrolysis, the method comprising:
passing the flowable suspension through a first downward conduit section;
passing the flowable suspension through a first connecting conduit section having a first upward part, the first connecting conduit section being configured to connect an outlet of the first downward conduit section with an inlet of a second downward conduit section; and
passing the flowable suspension through the second downward conduit section,
wherein a first flow velocity in the first upward part exceeds a second flow velocity in each of the first downward conduit section and the second downward conduit section.

2. The method as recited in claim 1, further comprising passing the flowable suspension through at least one additional connecting conduit section arranged downstream of the second downward conduit section, each of the at least one additional connecting conduit section having an upward part, and through at least one additional downward conduit section, wherein the at least one additional connecting conduit section is configured to connect an outlet of at least one of the second downward conduit section and the at least one additional downward conduit section arranged upstream with an inlet of the at least one additional downward conduit section arranged downstream, wherein a first flow velocity in at least one of the first upward part and the upward part exceeds a second flow velocity in the least one additional downward conduit section.

3. The method as recited in claim 2, wherein the first connecting conduit section and the at least one additional connecting conduit section each further comprise at least one horizontal section, wherein a first flow velocity in at least one of the at least one horizontal section, the first upward part and the upward part exceeds the second flow velocity in at least one of the first downward conduit section, the second downward conduit section, and the at least one additional downward conduit section.

4. The method as recited in claim 2, wherein the first flow velocity in the first upward part and in the upward part is at least twice as high as the second flow velocity in the first downward conduit section, the second downward conduit section and in the at least one additional downward conduit section.

5. The method as recited in claim 2, wherein the first flow velocity in the first upward part and in the upward part is greater than 0.5 m/s.

6. The method as recited in claim 2, wherein the second flow velocity in the first downward conduit section, the second downward conduit section, and the at least one additional downward conduit section is less than 0.25 m/s.

7. A device for subjecting a flowable suspension comprising a biogenic material to a temperature hydrolysis, the device comprising:
a first downward conduit section;
a second downward conduit section, wherein the first downward conduit section and the second downward conduit section are configured to have the flowable suspension pass sequentially therethrough; and
a first connecting conduit section having a first upward part, the first connecting conduit section being configured to connect an outlet of the first downward conduit section with an inlet of the second downward conduit section, and the first upward part being configured so that the flowable suspension passes through the first upward part when flowing from the first downward conduit section to the second downward conduit section,
wherein a cross-sectional flow area of the first upward part is smaller than a cross-sectional flow area of each of the first downward conduit section and the second downward conduit section.

8. The device as recited in claim 7, wherein the device further comprises at least one additional downward conduit section disposed downstream of the second downward conduit section, the at least one additional downward conduit section being configured to have the flowable suspension pass therethrough; and
at least one additional connecting conduit section comprising an upward part, the at least one additional connecting conduit section being configured to connect an outlet of at least one of the at least one additional downward conduit section and the second downward conduit section arranged upstream with an inlet of the at least one additional downward conduit section arranged downstream, the upward part being configured to have the flowable suspension pass therethrough when flowing from the at least one of the at least one additional downward conduit section and the second downward conduit section arranged upstream to the at least one additional downward conduit section arranged downstream,
wherein a cross-sectional flow area of the upward part is smaller than a cross-sectional flow area of each of first downward conduit section, the second downward conduit section and the at least one additional downward conduit section.

9. The device as recited in claim 8, further comprising a heat exchanger formed by a part of at least one of the first downward conduit section, the second downward conduit section the at least one additional downward conduit section, the heat exchanger being configured to at least one of transfer a heat from and to the flowable suspension upon the flowable suspension passing therethrough.

10. The device as recited in claim 9, wherein the heat exchanger is formed by two or more of the first downward conduit section, the second downward conduit section, and the at least one additional downward conduit section.

11. The device as recited in claim 8, further comprising a hydrolysis chamber formed by at least one of the first downward conduit section, the second downward conduit section and the at least one additional downward conduit section, the hydrolysis chamber being configured to maintain the flowable suspension within a preset temperature and a preset pressure range.

12. The device as recited in claim 8, wherein at least one of the first downward conduit section, the second downward conduit section and the at least one additional downward conduit section is inclined relative to a horizontal by at least 40°.

13. The device as recited in claim 8, wherein at least one of the first upward part and the upward part is inclined relative to a horizontal by at least 40°.

14. The device as recited in claim 8, wherein the cross-sectional flow area of at least one of the first upward part and the upward part is less than or equal to half the cross-sectional flow area of at least one of the first downward conduit section, the second downward conduit area and the at least one additional downward conduit section.
